(19) United States
(12) Patent Application Publication
(10) Pub. No.: US 2020/0326242 A1
(43) Pub. Date: Oct. 15, 2020

(54) VESSEL WITH TEMPERATURE INDICATOR

(71) Applicant: SafeSoak, LLC, Danvers, MA (US)

(72) Inventor: Matthew Capozzi, Danvers, MA (US)

(21) Appl. No.: 16/846,226

(22) Filed: Apr. 10, 2020

Related U.S. Application Data
(60) Provisional application No. 62/833,582, filed on Apr. 12, 2019.
(60) Provisional application No. 62/837,104, filed on Apr. 22, 2019.

(51) Int. Cl. G01K 11/12; A61H 35/00

(52) U.S. Cl. CPC G01K 11/12; A61H 35/006

(57) ABSTRACT

A vessel configured to contain a fluid. The vessel includes a body having a base, and left, right, front, and rear sides, and a central longitudinal axis. A raised portion projects from the base and is disposed along at least part of the central axis. A temperature indicator comprised of thermochromic material that responds to the temperature of the fluid is located in at least part of the raised portion.

### CROSS-REFERENCE TO RELATED APPLICATIONS

The present disclosure is related and claims priority to U.S. Provisional Pat. Appl. No. 62/833,582, filed on Apr. 12, 2019, and U.S. Provisional Pat. Appl. No. 62/837,104, filed on Apr. 22, 2019, the contents of each are hereby incorporated by reference in their entirety, for all purposes.

### BACKGROUND

### Field of Disclosure

Embodiments described herein are generally related to vessels that hold a fluid used to bathe a subject. More specifically, embodiments described herein are related to vessels that include a temperature indicator to tell the subject whether the fluid is too hot to contact. One or more of these embodiments may be employed to reduce the risk of scalding the subject.

### Related Art

Current vessels used to bathe a subject typically have no built-in indictors that accurately alert the subject about the temperature of the fluid in the vessel. Devices such as thermometers may be used with the vessel. But this can be cumbersome because the devices are generally separate from the vessel and the user must remember to get and use them when using the vessel. Failure to use these devices could create a hazard because the fluid temperature would be unknown and potentially too high. Therefore, it is desirable to have vessels that include an accurate, easy to understand temperature indicator so users can be assured that the fluid will not scald them.

### SUMMARY

In one embodiment, a vessel for containing a fluid includes a body having a base and left, right, top, and bottom sides. The vessel has a central, longitudinal axis that runs from the front side to the rear side. The vessel can be made from polymer and has a body that includes a raised portion projecting from the base along at least part of the central axis. A temperature indicator is located in at least part of the raised portion that responds to temperature of the fluid. The temperature indicator can include thermochromic material that provides the user with a visual representation of the temperature by changing color at a predetermined temperature. The visual representation can be words, letters, numbers, and/or other characters, figures, or graphic designations that the user can easily understand. The temperature indicator can be removed from the vessel and replaced. This allows the user to switch to a new indicator that changes color at a new predetermined temperature if the user needs notice of a different (e.g., safe) fluid temperature. The temperature indicator can include a keyed edge that mates with a corresponding keyed opening in the vessel.

In other embodiments, the vessel includes various interior features such as raised areas, support surfaces, and rest areas. Furthermore, the vessel interior can have various surface textures to facilitate use and therapy. To help with use and storage, the vessel can include handles and a mounting hole for hanging, e.g., on a wall. To improve hygiene, antimicrobial material may be included in the body of the vessel or in the temperature indicator.

### BRIEF DESCRIPTION OF THE DRAWINGS

FIGS. 1A-1H illustrate perspective views of a vessel with a temperature indicator, according to some embodiments.

FIG. 2A illustrates a top view of a vessel with a temperature indicator, according to some embodiments.

FIG. 2B illustrates a bottom view of a vessel with a temperature indicator, according to some embodiments.

FIG. 3A illustrates a left side view of a vessel with a temperature indicator, according to some embodiments.

FIG. 3B illustrates a right side view of a vessel with a temperature indicator, according to some embodiments.

FIG. 4A illustrates a front side view of a vessel with a temperature indicator, according to some embodiments.

FIG. 4B illustrates a rear side view of a vessel with a temperature indicator, according to some embodiments.

FIGS. 5A-5F illustrates a temperature indicator used in a vessel with a temperature indicator, according to some embodiments.

In the figures, elements and steps denoted by the same or similar reference numerals are associated with the same or similar elements and steps, unless indicated otherwise.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

Embodiments of the invention as disclosed herein include vessels (synonymous with basins) that hold a fluid used to bathe a subject, such as a human patient or an appendage thereof. The fluid can be water or another solution, such as water with Epsom salt added. Embodiments of the invention provide an indicator in the vessel that alerts the subject that the temperature of the fluid in the vessel is impermissibly high. This reduces the danger of scalding the subject. For example, a subject might be unable to sense the high temperature of the fluid because the subject suffers from certain infirmities, such as neuropathy. Furthermore, if a second party is assisting the subject with the bathing, the second party might be unable to detect the high temperature if, for example, the second party is wearing gloves Embodiments of the invention reduce the risk of scalding by giving the user an accurate, visual indication of the fluid temperature that responds quickly to the actual temperature.

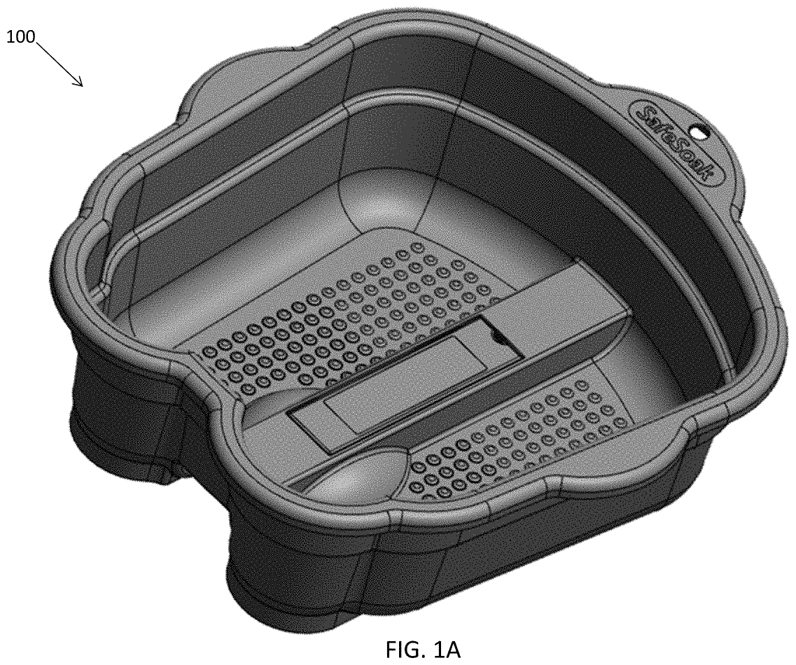

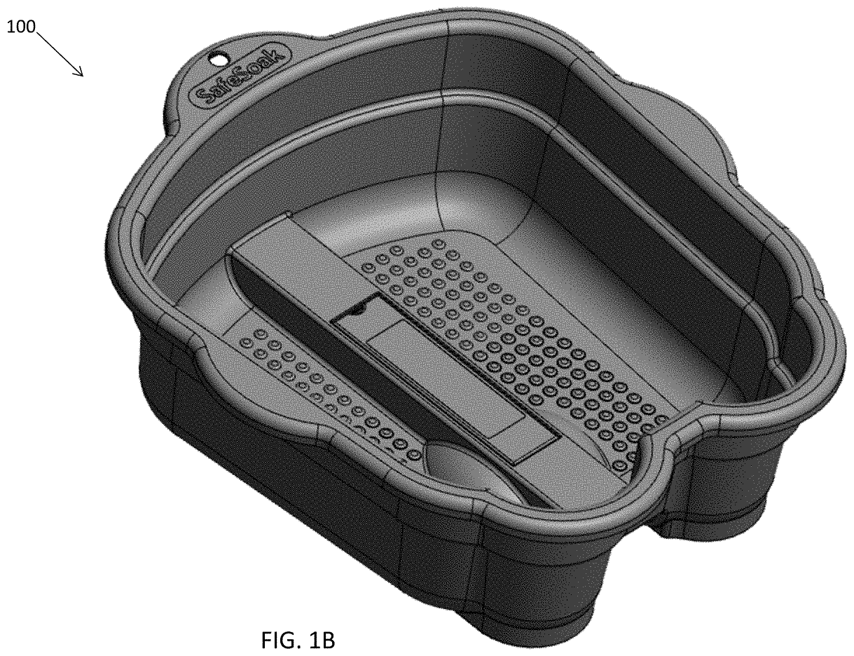

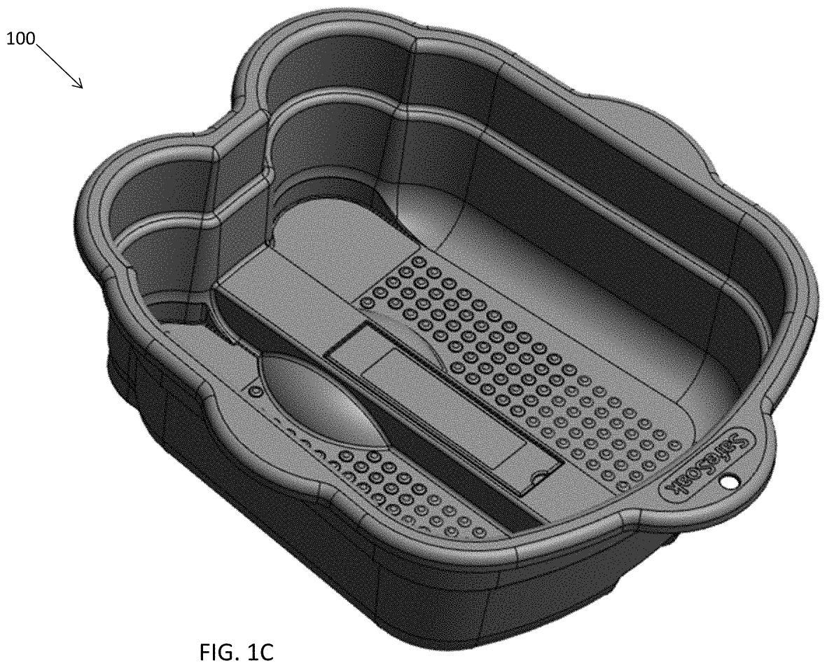

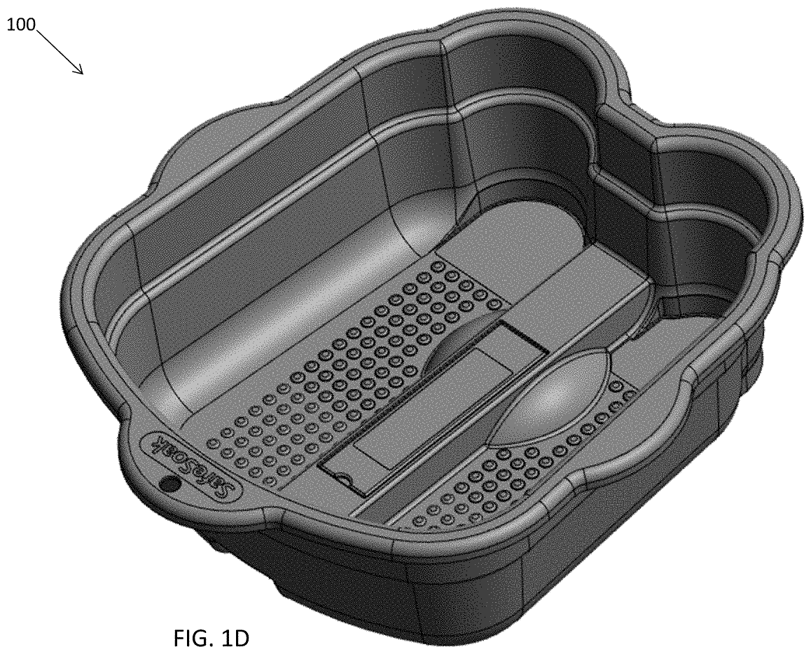

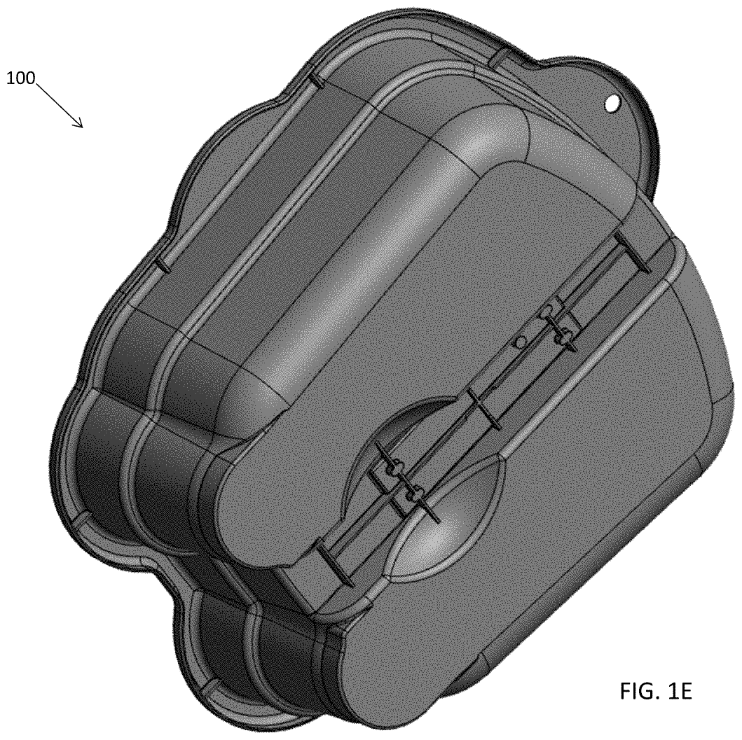

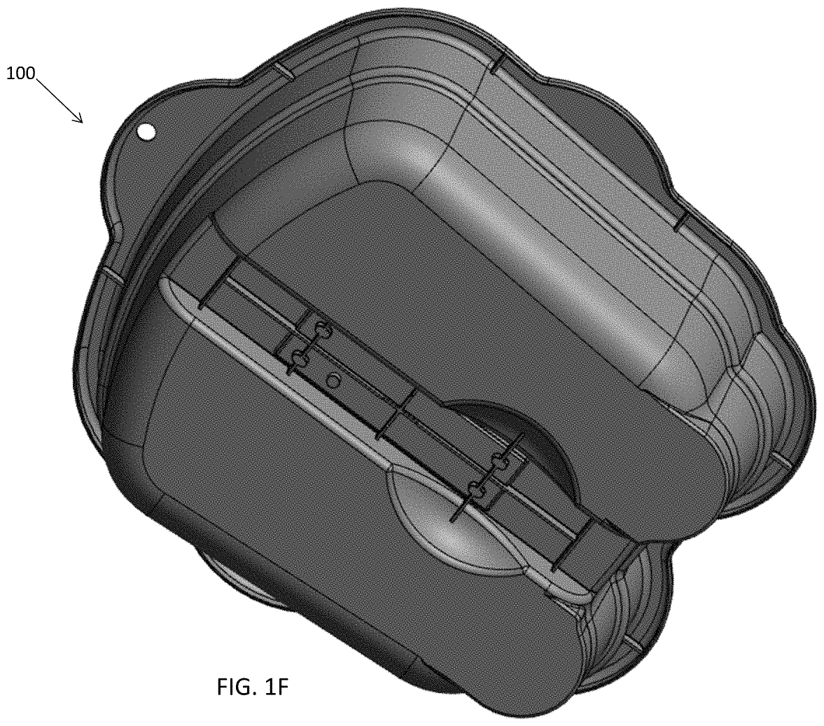

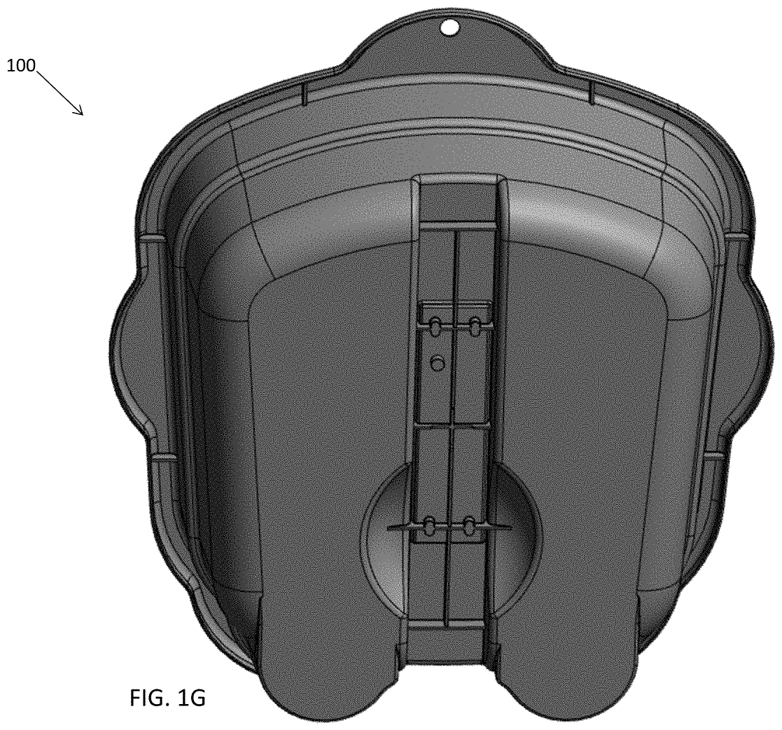

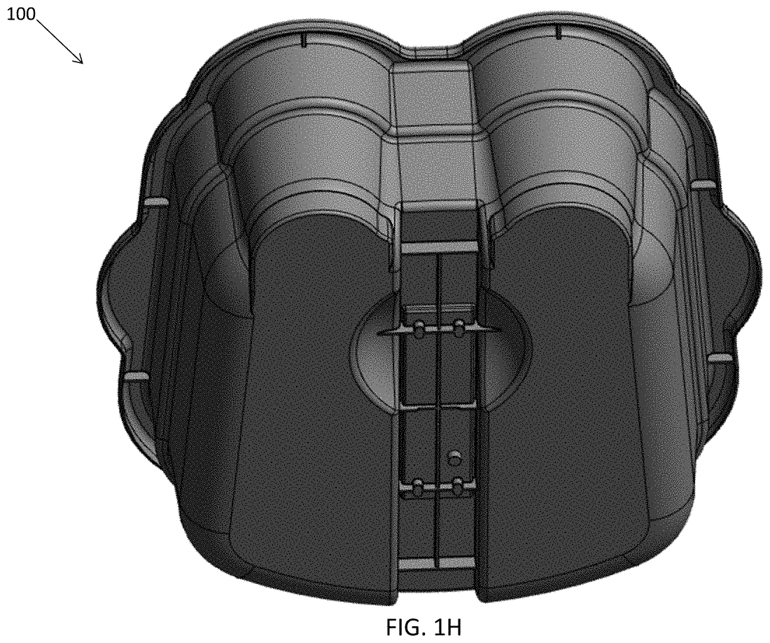

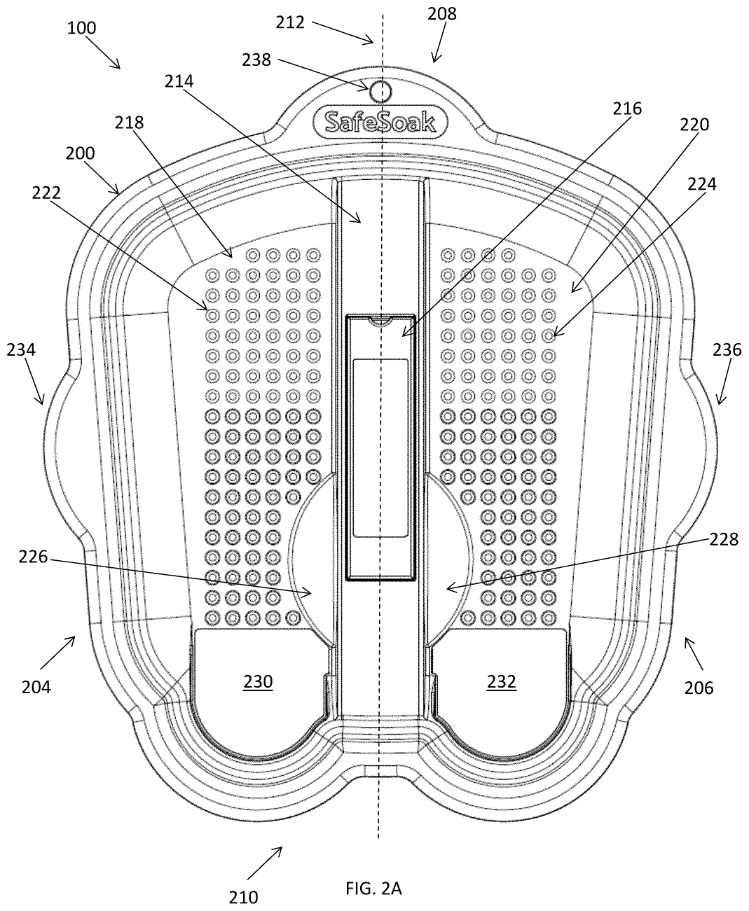

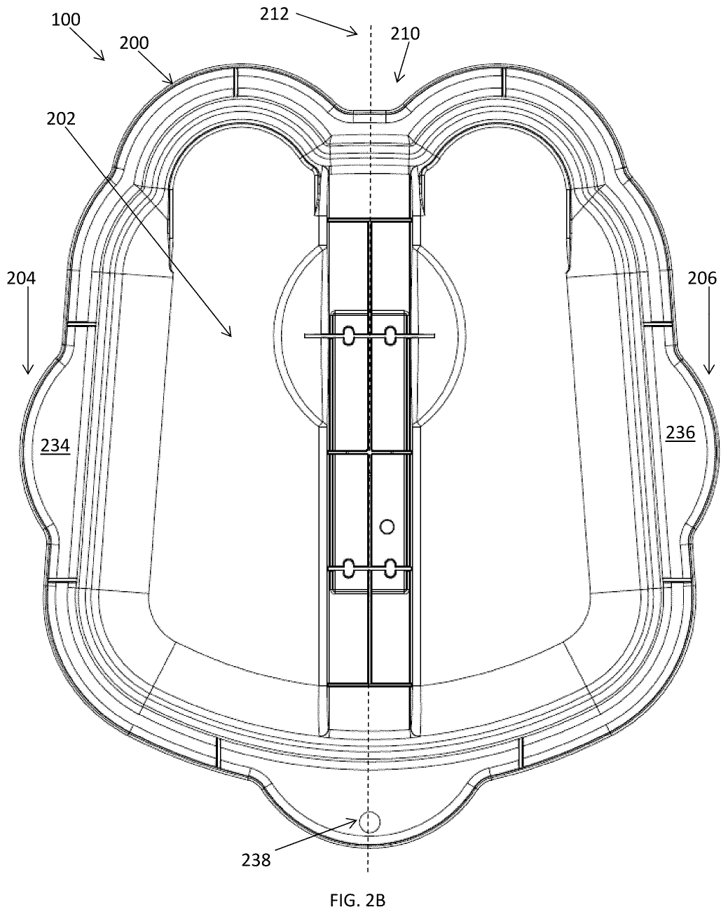

FIGS. 1A-1H are perspective views of a vessel 100 configured to contain a fluid, according to some embodiments. As shown in FIG. 2A, the vessel 100 includes a body 200. The body 200 includes a left side 204, a right side 206, a front side 208, and a rear side 210. The body 200 includes a base 202 shown in FIG. 2B.

In some embodiments, the vessel 100 defines a central axis 212 in a longitudinal direction, oriented from the front side 208 to the back side 210. The central axis 212 divides the vessel 100 such that the left side 204 and the right side 206 are approximately equal in size. In other embodiments, the body 200 includes a raised portion 214 disposed along and/or parallel to at least part of the central axis 212 that projects upward from the base 202. The raised portion 214 provides at least a partial separation between the left side 204 and the right side 206. In certain embodiments, a temperature indicator 216 is mounted on at least part of the raised portion 214. In other embodiments the raised portion 214 defines an opening and/or depression into which the temperature indicator 216 fits.

In certain embodiments, the base 202 includes a raised array 218 on the left side 204 and/or a raised array 220 on the right side 206. The raised arrays 218, 220, in some embodiments, include a textured or roughened surface. The textured surface can be uniform or non-uniform, and they may be the same as or different on the left side 204 compared to the right side 206. In some embodiments, the textured surface may include left side blisters 222 and/or right side blisters 224. The blisters 222, 224 may differ in size and shape within each raised array 218, 220.

In some embodiments, a left raised support 226 and/or a right raised support 228 are disposed along the central axis 212, with a raised support on each side of the central axis 212. One or both of the raised supports 226, 228 may include a textured or roughened surface.

In other embodiments, a left rest area 230 and/or a right rest area 232 are disposed along the central axis 212, with a rest area on each side of the central axis 212 near the back side 210. One or both of the rest areas 230, 232 may include a textured or roughened surface.

The textured or roughened surfaces included with the raised supports 226, 228 and/or rest areas 230, 232, can be uniform or non-uniform, and they may be the same as or different from each other. Furthermore, these textured or roughened surfaces can be the same or different from those included with raised array 218 or raised array 220.

Many human subjects, i.e., patients, find that soaking their feet provides pain relief or other therapeutic benefits. Consequently, certain embodiments of the invention are configured to receive one or both feet of a patient. In the latter case the raised portion 214 separates the patient's feet in the vessel 100. Additionally, the raised arrays 218, 220 provide a gripping surface and/or a surface the patient may move his feet across for a beneficial, kneading effect. Textured or roughened surfaces included with the raised supports 226, 228 and/or rest areas 230, 232 provide similar advantages and can facilitate exfoliation.

The raised supports 226, 228 may be located to contact some or all of the patient's arches, thereby providing additional reinforcement. The rest areas 230, 232 may be located to contact some or all of the patient's heels.

To simplify handling of the vessel 100, some embodiments include a left handle 234 and/or a right handle 236. The handles 234, 236 may be integrated (e.g., molded) into the body 200. Alternatively, the handles 234, 236 may be separate components that are attached to the vessel 100.

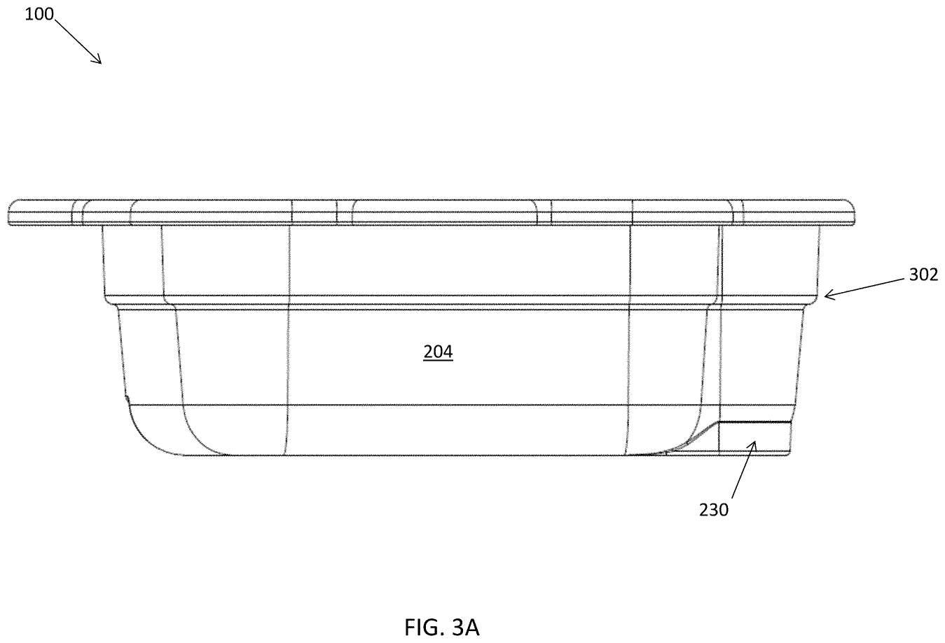

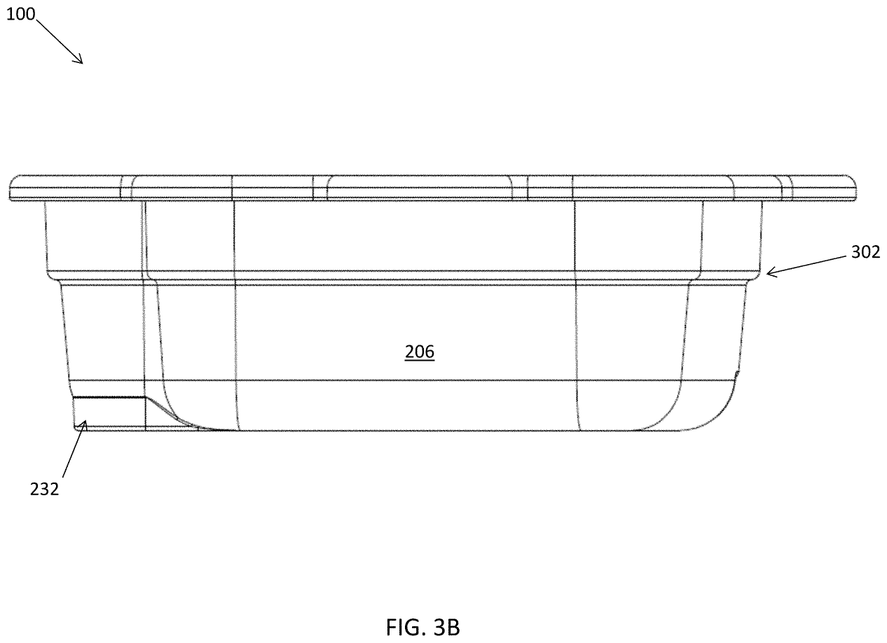

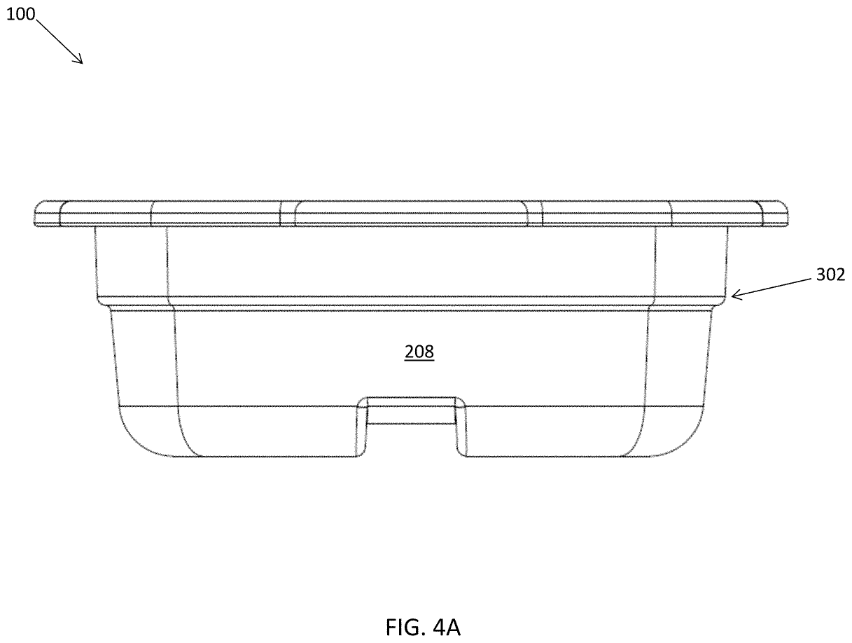

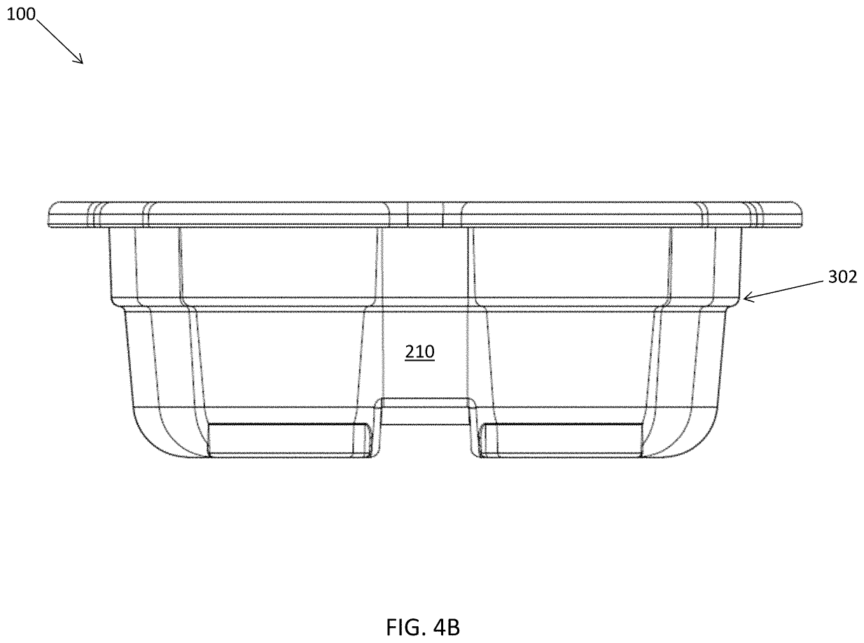

As shown in FIGS. 3A, 3B, 4A, and 4B, some embodiments the vessel 100 include a fill line 302 that identifies the proper level to which the vessel 100 is filled with fluid. In some embodiments the fill line 302 is embossed in the vessel 100. In other embodiments the fill line 302 is a feature applied on the surface of the vessel 100, for example, as a painted line. When filled with fluid, the vessel 100 can have a substantial weight. The handles 234, 236 assist a patient with moving the vessel 100, which is important when the patient has limited strength. To simplify storage, some embodiments of the vessel 100 include a least one mounting hole 238 that allows the vessel to be hung in a storage location, e.g., on a wall.

In some embodiments, the temperature indicator 216 is comprised of thermochromic (“TC”) material that changes color when exposed to a temperature at or above a predetermined value. For example, the TC material may be designed to change temperature at approximately 40 degrees C. A bathing fluid temperature above 40 degrees C. can be hazardous for certain patients.

Other embodiments include TC material that changes color at other temperatures that are appropriate for the intended use of the vessel 100. For example, certain patients might require a lower bathing temperature. Other patients might need and could tolerate a higher temperature. In either case, the corresponding TC material would be designed to change color at the appropriate temperature limit (the “design change temperature” or “DCT”). TC color changes typically have high-contrast and are easily discernable.

In certain embodiments, the TC material may be integrated into the vessel 100. This includes embodiments where some or all of the entire vessel 100 is comprised of TC material. In these embodiments, some or all of the vessel 100 changes color at the DCT.

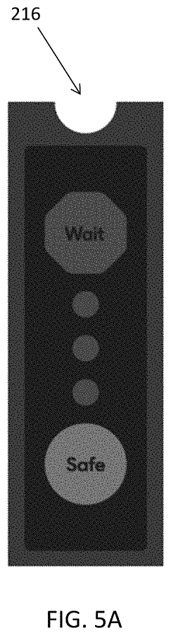

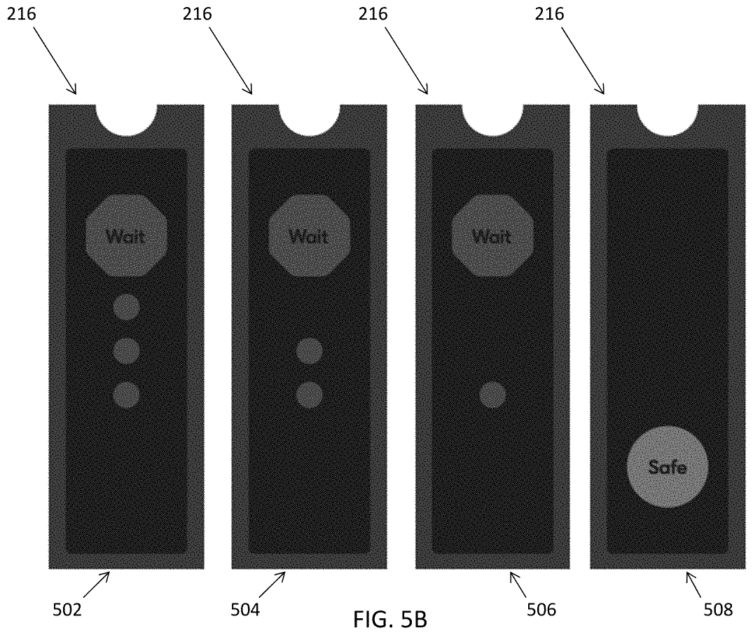

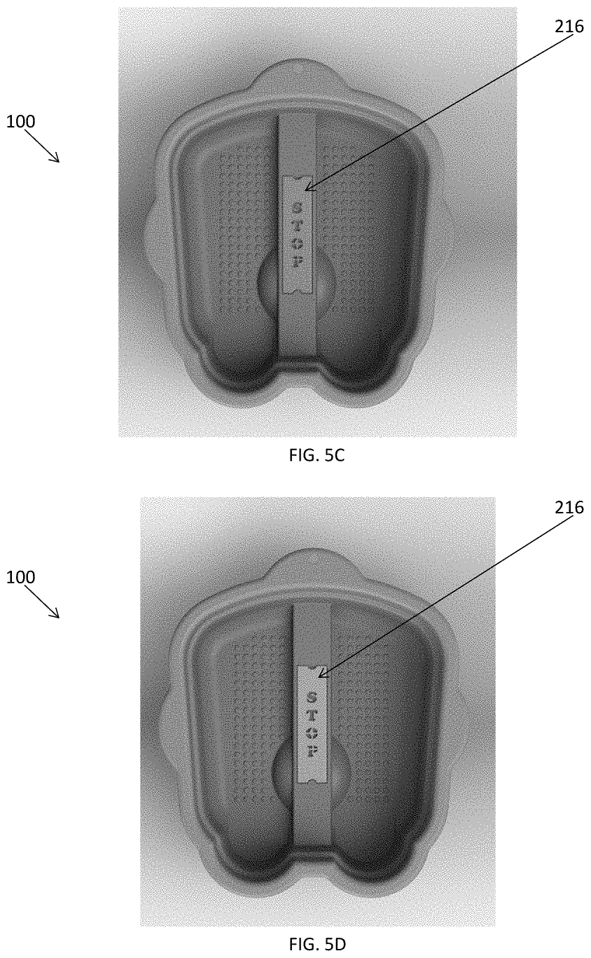

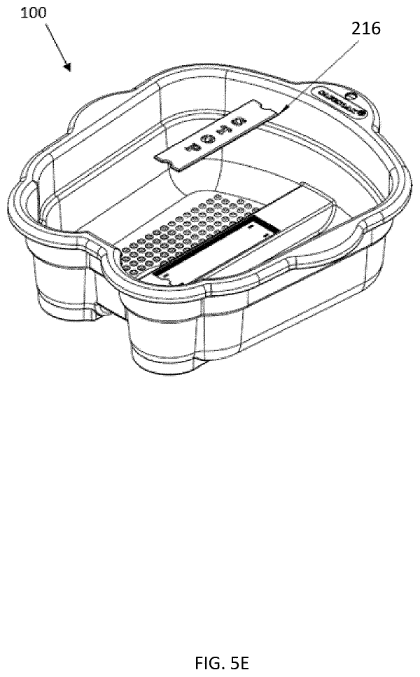

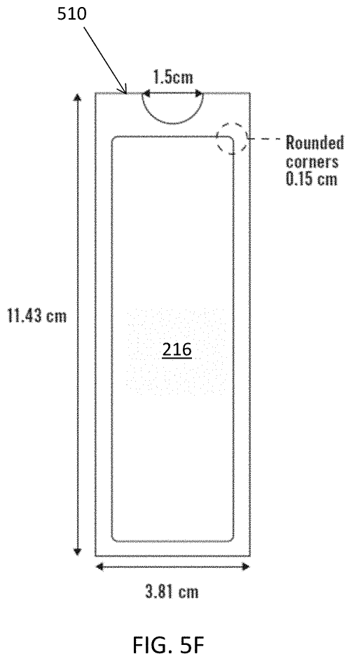

The temperature indicator 216 may be unmarked or, in other embodiments, include words, letters, numbers, and/or other characters, figures, or graphic designations to, for example, facilitate interpretation of the high temperature warning. As shown in FIG. 5A, the temperature indicator 216 in some embodiments includes several graphic designations that appear individually or in certain combinations as the temperature of the fluid in the vessel 100 changes.

For example, FIG. 5B shows various states 502-508 of the temperature indicator 216 corresponding to various temperatures in one embodiment. State 502 represents the condition where the temperature of the fluid in the vessel 100 is greater than or equal to approximately 46 degrees C. In this state 502 the temperature indicator 216 displays a “Wait” graphic with three dot graphics that represent a temperature countdown. State 504 represents the condition where the temperature of the fluid in the vessel 100 has cooled to approximately 44 degrees C. In this state 504 the temperature indicator 216 displays the “Wait” graphic with two dot countdown graphics. State 506 represents the condition where the temperature of the fluid in the vessel 100 has cooled to approximately 42 degrees C. In this state 506 the temperature indicator 216 displays the “Wait” graphic with one dot countdown graphic. Embodiments that use the diminishing number of dot countdown graphics provide the patient with a visual indication of the cooling process.

When the temperature of the fluid in the vessel 100 reaches approximately at 40 degrees C., the temperature indicator 216 will reach state 508. In this state 508 the temperature indicator 216 displays a “Safe” graphic. This tells the patient that it is safe to come into contact with the fluid, e.g., by immersing his feet.

The color of the words, letters, numbers, and/or other characters, figures, or graphic designations included in the temperature indicator 216 may be chosen to emphasize the temperature warning. For example, in some embodiments the “Wait” and dot countdown graphics in states 502, 504, and 506 may be red to underscore the danger associated with high temperature. The “Safe” graphic in state 508 may be blue in some embodiments to accentuate that the fluid in the vessel 100 has reached a temperature where it is safe to contact.

In some embodiments, the temperature indicator 216 may include warning language that is cut in to or through the temperature indicator 216. This is useful when the color of the vessel 100 matches the color of the TC material in the temperature indicator 216 when the TC material is below its DCT. In this configuration, the warning language is partially or completely invisible until the TC material reaches its DCT. At that point the TC material changes color and the contrast between it and the underlying vessel 100 makes the warning language visible. The warning language can comprise words in English or other languages such as, for example: STOP, HALT, or HOT. The warning language can include symbols that communicate the high temperature warning as well. By way of example, these can include a circle with a diagonal line through it, or a graphic showing a foot or feet, optionally with a line through it or them.

FIG. 5C depicts an embodiment where the temperature indicator 216 has the word STOP cut through it and, when below the DCT, matches the color of the vessel 100. In this case the word STOP is virtually invisible (although enhanced for the purpose of in FIG. 5C). FIG. 5D depicts the same embodiment when the temperature indicator 216 reaches the DCT. FIG. 5D shows that the contrasting color of the TC material in the temperature indicator 216 makes the word STOP visible.

The temperatures associated with the states 502-508 are exemplary and may differ in other embodiments. Different temperatures, i.e., DCTs, might be appropriate for different uses of the vessel 100. For example, to accommodate different temperature limits needed by different patients, FIG. 5E shows another embodiment that includes a feature where the temperature indicator 216 is removable from the vessel 100 and replaceable. That allows the end user to change the TC material based on the DCT needed or to replace the TC material that might have been damaged or reached an end-of-life condition. The removable temperature indicator 216 may have warning language that is cut in to or through it as shown in FIG. 5E and/or include one or more graphic designations as shown in FIG. 5A.

FIG. 5F depicts an embodiment in which the temperature indicator 216 includes a keyed edge portion 510 that is configured to fit a corresponding keyed opening and/or depression in the raised portion 214. The dimensions shown in FIG. 5F are exemplary. An interference fit between the keyed opening and/or depression in the raised portion 214 and the temperature indicator 216 secures the latter to the vessel 100. Other means of attaching the temperature indicator 216 to the vessel 100 include, in other embodiments, adhesives and/or mechanical fasteners, e.g., screws, bolts, clips, and the like. Other embodiments use magnetism (e.g., magnets) as the attachment means.

Other embodiments of the invention are directed to other applications. For example, some embodiments are bathing vessels for infants. The interior design for such vessels is typically different, i.e., the vessels are shaped and sized to allow an infant to rest comfortably in the vessel while being bathed. Typically, these embodiments lack one or more of the interior structures shown in FIG. 2A. However, these embodiments may include certain raised and/or sloped interior structures to support the infant. Also, these embodiments include the temperature indicator 216 in the vessel. In some of these embodiments, like those described above, the TC material may be integrated into the vessel, including embodiments where the entire vessel is comprised of TC material. In other embodiments the TC material is replaceable because the temperature indicator 216 is removable.

Still other embodiments of the invention are directed to vessels that second party assistants may use when treating the subject or patient. For example, a health care professional might use an embodiment as a vessel for performing sponge baths of a patient. Such embodiments include interior structures that are appropriate or needed for this task, and might lack one or more of the interior structures present in other embodiments. If the health care professional is wearing gloves, he likely cannot reliably determine the temperature of fluid in the vessel upon touch. This creates a hazard for the patient. Including TC material in such vessels, e.g., by way of the temperature indicator 216, eliminates this risk.

In some embodiments, the vessel 100 is constructed from plastic, typically through an injection molding process. Typical plastics used in some embodiments include polymers such as, for example, polyolefins. This includes polypropylene, polyethylene, high-density polyethylene, low density polyethylene, etc. In other embodiments the vessel 100 is constructed from other materials, including metals such as aluminum, titanium, or stainless steel, as well as from magnetic materials.

Some embodiments add antimicrobial material such as, for example, silver or silver compounds, to the vessel 100. This may be accomplished by, for example, adding the antimicrobial material to the material comprising the body. In embodiments that include an injection molded vessel 100, this may include adding the antimicrobial material to the material, e.g., resin, used to form the body 200. Other embodiments can include adding the antimicrobial material to the temperature indicator 216. With a replaceable temperature indicator 216, this configuration allows for the change and renewal of the antimicrobial material. Some embodiments include a separate fixed or removable container of antimicrobial material mounted within the vessel 100.

According to some embodiments, a method of using the vessel 100 includes the step of a user filling the vessel 100 with a fluid, observing the temperature indicator 216, waiting until the temperature indicator 216 shows that the fluid is safe, e.g., in state 508, and then immersing the subject (i.e., patient) or an appendage thereof in the vessel.

To the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112(f), unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

1. A vessel configured to contain a fluid, comprising:
a body, the body comprising a base, a left side, a right side, a front side, and a rear side;
wherein the vessel defines a central axis located between the left side and the right side and oriented longitudinally from the front side to the rear side;
the body further comprising:
a raised portion projecting from the base and disposed along at least part of the central axis; and
a temperature indicator located in at least part of the raised portion that responds to the temperature of the fluid.

2. The vessel of claim 1, wherein the temperature indicator comprises thermochromic material.

3. The vessel of claim 2, wherein the thermochromic material changes color at a predetermined temperature.

4. The vessel of claim 3, wherein the predetermined temperature is approximately 40 degrees C.

5. The vessel of claim 1, wherein the temperature indicator comprises at least one graphic designation corresponding to a temperature of the fluid.

6. The vessel of claim 1, wherein the temperature indicator defines at least one opening.

7. The vessel of claim 6, wherein the at least one opening corresponds to at least one of a letter, word, and symbol.

8. The vessel of claim 1, wherein the temperature indicator is removable from the raised portion.

9. The vessel of claim 1, wherein the temperature indicator comprises a keyed edge portion configured to fit in a keyed opening in the raised portion.

10. The vessel of claim 1, wherein at least part of the base comprises a raised array on at least one side of the central axis.

11. The vessel of claim 10, wherein the raised array comprises a plurality of raised blisters.

12. The vessel of claim 1, wherein the base comprises a raised support on at least one side of the central axis adjacent to the raised portion.

13. The vessel of claim 1, wherein at least part of the base comprises a rest area on at least one side of the central axis adjacent to the rear side.

14. The vessel of claim 13, wherein the rest area comprises a roughened surface.

15. The vessel of claim 1, wherein the body comprises an antimicrobial material.

16. The vessel of claim 15, wherein the antimicrobial material comprises silver.

17. The vessel of claim 1, wherein the body comprises polymer.

18. The vessel of claim 1, wherein at least one of the left side and the right side comprises a handle.

19. The vessel of claim 1, wherein the front side defines at least one mounting hole.

20. A vessel configured to contain a fluid, comprising:
a body, the body comprising a base, a left side, a right side, a front side, and a rear side;
wherein the vessel defines a central axis located between the left side and the right side and oriented from the front side to the rear side;
the body further comprising:
a raised portion projecting from the base and disposed along the central axis; and
a removable temperature indicator located in at least part of the raised portion that responds to the temperature of the fluid;
wherein the removable temperature indicator comprises thermochromic material and at least one symbol, each at least one symbol corresponding to a predetermined temperature; and
wherein the at least one symbol includes at least one of a wait symbol, a safe symbol, and a countdown symbol.

21. A temperature indicator configured to fit within a keyed opening in a vessel, comprising:
thermochromic material that changes color at a predetermined temperature;
a wait symbol, a safe symbol, and a plurality of countdown symbols; and
a keyed edge portion configured to fit in the keyed opening in the vessel.

22. The temperature indicator of claim 21, further comprising antimicrobial material.
